(19) United States
(12) Patent Application Publication
(10) Pub. No.: US 2020/0166950 A1
(43) Pub. Date: May 28, 2020

(54) AUTOMATIC DRIVING CONTROL DEVICE

(71) Applicant: DENSO CORPORATION, Kariya-city (JP)

(72) Inventors: Tomomi HASE, Kariya-city (JP); Noriaki IKEMOTO, Kariya-city (JP); Mitsuharu HIGASHITANI, Kariya-city (JP)

(73) Assignee: DENSO CORPORATION, Kariya-city (JP)

(21) Appl. No.: 16/779,938

(22) Filed: Feb. 3, 2020

Related U.S. Application Data
(63) Continuation of application No. PCT/JP2018/026201, filed on Jul. 11, 2018.

(30) Foreign Application Priority Data
Aug. 2, 2017 (JP) 2017-149610

(51) Int. Cl. G05D 1/02; G08G 1/0965; G05D 1/00; B60W 60/00

(52) U.S. Cl. CPC G05D 1/0276; G08G 1/0965; B60W 2554/402; B60W 60/0017; B60W 2554/4045; G05D 1/0088

(57) ABSTRACT

An automatic driving control device mounted in an automatic driving vehicle for executing automatic driving along a planned travelling route includes: a driving execution unit that executes driving of the automatic driving vehicle; a communication unit that communicates with outside of the automatic driving vehicle; and a control unit that executes the automatic driving by controlling the driving execution unit. The communication unit has a first receiving unit that receives instruction signals for instructing driving contents of the automatic driving vehicle. The control unit has a first determination unit that determines provisional driving contents which are the driving contents of the automatic driving vehicle according to the instruction signals, when the instruction signals are received during execution of the automatic driving, and the control unit executes the automatic driving using the determined provisional driving contents.

This application is the U.S. bypass application of International Application No. PCT/JP2018/026201 filed Jul. 11, 2018 which designated the U.S. and claims priority to Japanese Patent Application No. 2017-149610, filed Aug. 2, 2017, the contents of which are incorporated herein by reference.

### BACKGROUND

### Technical Field

The present disclosure relates to an automatic driving control device.

### Description of the Related Art

A patent literature discloses a display system in which sound data transmitted by an emergency vehicle is received by any other vehicle, and a character or image corresponding to the sound data is displayed on a display device of the vehicle.

### SUMMARY

One aspect of the present disclosure provides an automatic driving control device. This automatic driving control device is an automatic driving control device mounted in an automatic driving vehicle for executing automatic driving along a planned travelling route, including: a driving execution unit that executes driving of the automatic driving vehicle; a communication unit that communicates with outside of the automatic driving vehicle; and a control unit that executes the automatic driving by controlling the driving execution unit.

### BRIEF DESCRIPTION OF THE DRAWINGS

The above and other purposes, features and advantages of the present disclosure will become more apparent from the following detailed description with reference to the accompanying drawings.

In the accompanying drawings:

FIG. 1 is a block diagram showing the overall configuration of an automatic driving control device in an embodiment of the present disclosure;

FIG. 2 is a flowchart showing an automatic driving control process to be executed by a control unit;

FIG. 3 is a flowchart showing a vehicle driving execution process;

FIG. 4 is a flowchart showing a conclusive driving content determination process;

FIG. 5 is an explanatory view showing a state when instruction signals have been output from the emergency vehicle;

FIG. 6 is an explanatory view showing a state after execution of operations of an automatic driving vehicle after reception of the instruction signals;

FIG. 7 is an explanatory view showing a state when instruction signals have been output to two automatic driving vehicles from the emergency vehicle;

FIG. 8 is an explanatory view showing a state after execution of operations of the automatic driving vehicles after the automatic driving vehicles have received the instruction signals from the emergency vehicle;

FIG. 9 is an explanatory view showing a state when instruction signals have been output to two automatic driving vehicles from the emergency vehicle;

FIG. 10 is an explanatory view showing a state when instruction signals have been output to one automatic driving vehicle from the emergency vehicle;

FIG. 11 is an explanatory view showing a state after execution of operations of the automatic driving vehicle after the automatic driving vehicle has received the instruction signals from the emergency vehicle;

FIG. 12 is an explanatory view showing a state when instruction signals have been output from the emergency vehicle to an automatic driving vehicle traveling at the tail end of vehicle platooning;

FIG. 13 is an explanatory view showing a state after execution of operations of the platooning automatic driving vehicles after the automatic driving vehicles have received the instruction signals from the emergency vehicle;

FIG. 14 is an explanatory view showing a state when instruction signals have been output from the emergency vehicle to an automatic driving vehicle traveling at the tail end of vehicle platooning;

FIG. 15 is an explanatory view showing a state after execution of operations of platooning automatic driving vehicles after the automatic driving vehicles have received the instruction signals from the emergency vehicle;

FIG. 16 is an explanatory view showing a state when instruction signals have been output from the emergency vehicle to an automatic driving vehicle traveling at the tail end of vehicle platooning;

FIG. 17 is an explanatory view showing a state after execution of operations of platooning automatic driving vehicles after the automatic driving vehicles have received the instruction signals from the emergency vehicle;

FIG. 18 is an explanatory view showing a state when instruction signals have been output to automatic driving vehicles from the emergency vehicle;

FIG. 19 is an explanatory view showing a state after execution of operations of the automatic driving vehicles after the automatic driving vehicles have received the instruction signals from the emergency vehicle;

FIG. 20 is an explanatory view showing a state when instruction signals have been output to automatic driving vehicles from the emergency vehicle; and

FIG. 21 is an explanatory view showing a state after execution of operations of the automatic driving vehicles after the automatic driving vehicles have received the instruction signals from the emergency vehicle.

### DETAILED DESCRIPTION OF THE PREFERRED EMBODIMENTS

According to the above-described patent literature, that is, JP 2014-241055 A, when the display system according to the above-described patent literature is mounted in an automatic driving vehicle which automatically drives along a planned travelling route, there is a problem that, even if a character or image corresponding to sound data is displayed on the display device, a passenger of the automatic driving vehicle may not notice it and thus cannot respond to the emergency vehicle. Further, a case has not been fully considered in which the automatic driving vehicle receives information indicating an instruction concerning driving of the vehicle from an emergency vehicle, a control center, or the like during automatic driving, and how the automatic driving vehicle should respond to the instruction.

The present disclosure has been achieved in light of the above-described circumstances and is embodied in various manner. Hereinafter, embodiments of the present disclosure will be described with reference to the drawings.

### First Embodiment

A1. Device Configuration:

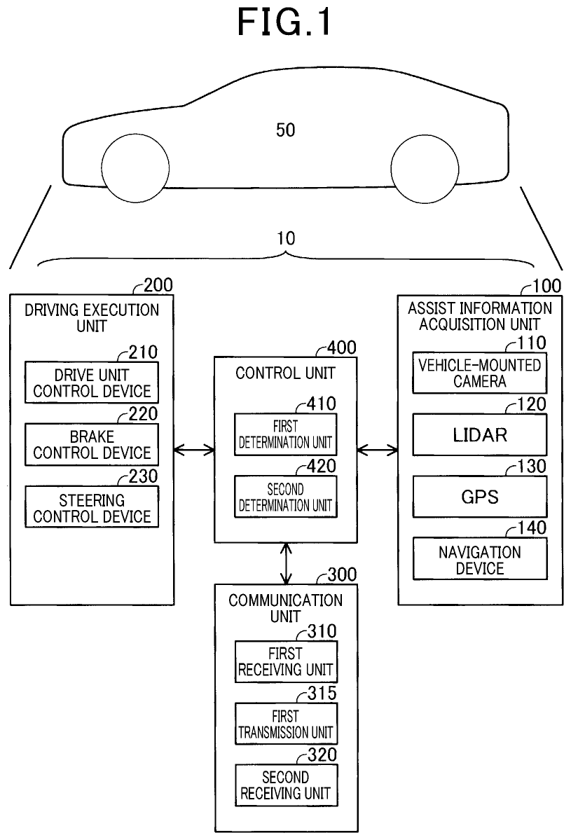

An automatic driving control device 10 shown in FIG. 1 is mounted in an automatic driving vehicle 50 for performing automatic driving along a planned travelling route, and performs the automatic driving of the automatic driving vehicle 50. As used herein, the “automatic driving” means driving in which all of drive unit control, brake control and steering angle control are automatically executed without a passenger of the automatic driving vehicle 50 performing driving operations. Therefore, in automatic driving, an operation state of a drive unit, an operation state of a brake mechanism, and a steering angle of wheels are automatically determined.

The automatic driving control device 10 includes an assist information acquisition unit 100, a driving execution unit 200, a communication unit 300, and a control unit 400.

The assist information acquisition unit 100 acquires various pieces of assist information for automatic driving. The assist information acquisition unit 100 includes a vehicle-mounted camera 110, a LIDAR 120, a GPS 130, and a navigation device 140.

The vehicle-mounted camera 110 captures images in a peripheral environment of the automatic driving vehicle 50. Image data representing an image taken by the vehicle-mounted camera 110 is output to the control unit 400. The vehicle-mounted camera 110 is configured as a CCD camera. The vehicle-mounted camera 110 may be a CMOS image sensor or a near infrared camera.

The LIDAR 120 emits electromagnetic waves having a relatively short wavelength and receives the reflected waves thereof to detect the distance to a target and the direction in which the target exists. The information on the target detected by the LIDAR 120 is output to the control unit 400.

The GPS 130 detects the current location of the automatic driving vehicle 50. The information on the current location of the automatic driving vehicle 50 detected by the GPS 130 is output to the control unit 400.

The navigation device 140 determines a planned travelling route in automatic driving based on the destination and the current location of the automatic driving vehicle 50 detected by the GPS 130. The information on the planned travelling route determined by the navigation device 140 is output to the control unit 400.

The driving execution unit 200 executes driving of the automatic driving vehicle 50. The driving execution unit 200 includes a drive unit control device 210, a brake control device 220, and a steering control device 230.

The drive unit control device 210 has the function of controlling a drive unit (not shown) that drives wheels of the automatic driving vehicle 50. As the drive unit for the wheels, one or more prime motors among internal combustion engines and electric motors can be used.

The brake control device 220 executes brake control of the automatic driving vehicle 50. The brake control device 220 is configured as an electronically controlled brake system (ECB), for example.

The steering control device 230 controls the steering angle of the wheels of the automatic driving vehicle 50. The steering control device 230 is configured as an electric power steering system (EPS), for example.

The communication unit 300 communicates with external equipment outside the automatic driving vehicle 50. The communication unit 300 is capable of performing an inter-vehicle communication with other automatic driving vehicles. Also, the communication unit 300 may be configured to be communicable with a control center in addition to the inter-vehicle communication with the other automatic driving vehicles. The communication unit 300 includes a first receiving unit 310, a first transmission unit 315, and a second receiving unit 320.

The first receiving unit 310 receives instruction signals for instructing driving contents of the automatic driving vehicle 50. As used herein, the instruction signal is a signal output to instruct a response different from normal automatic driving to the automatic driving vehicle 50, unlike information acquired, by the automatic driving vehicle 50, from infrastructures such as signals and signs installed on roads when the automatic driving vehicle 50 is executing the normal automatic driving. In this embodiment, the driving contents instructed by the instruction signals are driving contents performed on a road (movement in the front, rear, right and left directions of vehicles, or stop and acceleration/deceleration thereof), and do not include movement from a road on which the automatic driving vehicle 50 is traveling when having received the instruction signals to another road, i.e., route change. In other embodiments, the driving contents instructed by the instruction signals may include route change. In this embodiment, the instruction signals are output from an emergency vehicle. Examples of the instruction signals output from the emergency vehicle include those output when the emergency vehicle requests automatic driving vehicles which are present on a course of the emergency vehicle to give way. The instruction signals received by the first receiving unit 310 are transmitted to the control unit 400.

The first transmission unit 315 transmits first content signals indicating the driving contents indicated by the instruction signals which have been received by the first receiving unit 310, and provisional driving contents determined by the first determination unit 410, which will be described later, to any other automatic driving vehicles.

The second receiving unit 320 receives, from the other automatic driving vehicle, second content signals indicating the driving contents to be executed by the other automatic driving vehicle upon reception of the first content signals. The second content signals are transmitted to the control unit 400.

The control unit 400 controls the driving execution unit 200 to execute the automatic driving of the automatic driving vehicle 50. The driving contents of the automatic driving to be executed by the control unit 400 include traveling in the front, rear, right and left directions as well as stop and acceleration/deceleration of the automatic driving vehicle 50. Also, the control unit 400 controls various units of the automatic driving control device 10. The control unit 400 includes a first determination unit 410 and a second determination unit 420.

The first determination unit 410 determines provisional driving contents which are the driving contents of the automatic driving vehicle 50 according to the instruction signals, when the communication unit 300 receives the instruction signals while the automatic driving vehicle 50 is executing automatic driving. The reason for using the term “provisional driving contents” is because driving contents different from the provisional driving contents may be finally executed as the driving contents of the automatic driving vehicle 50 to be executed according to the instruction signals. The provisional driving contents are determined using information acquired by the vehicle-mounted camera 110 and the LIDAR 120. The provisional driving contents are transmitted to the communication unit 300.

The second determination unit 420 determines conclusive driving contents which are the driving contents of the automatic driving vehicle 50 according to the driving contents of the other automatic driving vehicle indicated by the second content signals and the driving contents indicated by the instruction signals. The control unit 400 executes the automatic driving of the automatic driving vehicle 50 based on the conclusive driving contents.

### A2. Automatic Driving Control Process:

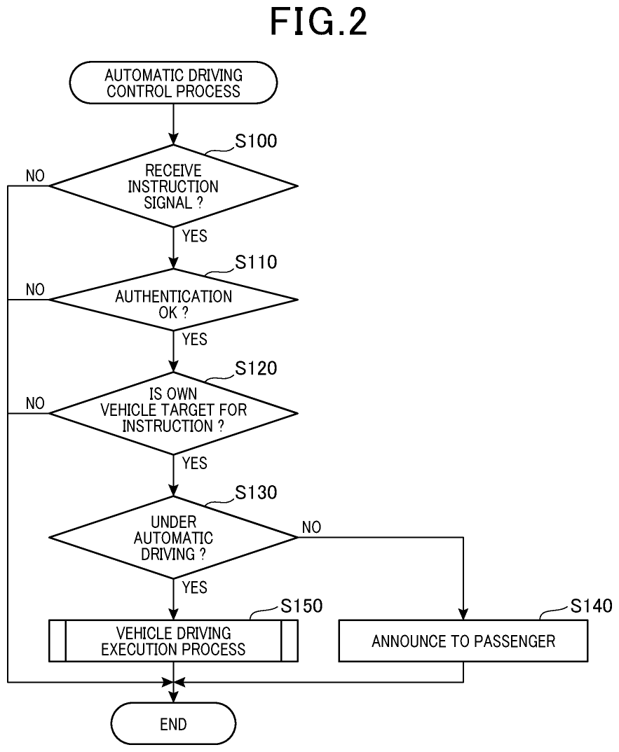

The control unit 400 executes an automatic driving control process shown in FIG. 2. The process is repeatedly executed during operation of the automatic driving vehicle 50.

When the automatic driving control process is activated, it is decided whether the control unit 400 has received instruction signals (step S100). When deciding that the control unit 400 has not received such instruction signals (step S100: NO), the control unit 400 terminates the automatic driving control process.

When deciding that the control unit 400 has received the instruction signals (step S100: YES), the control unit 400 authenticates whether the instruction signals are proper (step S110). As used herein, the “proper instruction signals” are instruction signals output from a vehicle which should have the authority to instruct driving contents to other automatic driving vehicles, i.e., in this embodiment, instruction signals output from the emergency vehicle. In this embodiment, the control unit 400 decides whether the instruction signals are proper, based on an identification code indicating a subject which has outputted the received instruction signals together with the instruction signals. The emergency vehicle which outputs the instruction signals outputs the identification code based on which the vehicle is identified as the emergency vehicle, together with the instruction signals.

When it cannot be authorized that the instruction signals are proper (step S110: NO), the control unit 400 terminates the automatic driving control process.

When it can be authorized that the instruction signals are proper (step S110: YES), the control unit 400 decides whether the automatic driving vehicle 50 is the target for instruction by the instruction signals (step S120). The control unit 400 decides whether the automatic driving vehicle 50 is the target for instruction, based on the identification code indicating the target for instruction by the received instruction signals together with the instruction signals. The emergency vehicle preliminarily acquires the identification code of the automatic driving vehicle to which the instruction signals are to be output, by communication with the automatic driving vehicle, before output of the instruction signals. The emergency vehicle may preliminarily acquire the identification code of the automatic driving vehicle to which the instruction signals are output, by communication with a control center, in place of communication with the automatic driving vehicle.

When deciding that the automatic driving vehicle 50 is not a target for the instruction signals (step S120: NO), the control unit 400 terminates the automatic driving control process.

When deciding that the automatic driving vehicle 50 is a target for the instruction signals (step S120: YES), the control unit 400 decides whether the automatic driving vehicle 50 is under automatic driving (step S130).

When the automatic driving vehicle 50 is not under automatic driving (step S130: NO), the control unit 400 announces the driving contents indicated by the instruction signals to the passenger of the automatic driving vehicle 50. The announcing means may be either sound output or display on an instrument panel or a display device mounted in the vehicle.

When the automatic driving vehicle 50 is under automatic driving (step S130: YES), the control unit 400 performs a vehicle driving execution process (step S150).

### A3. Vehicle Driving Execution Process:

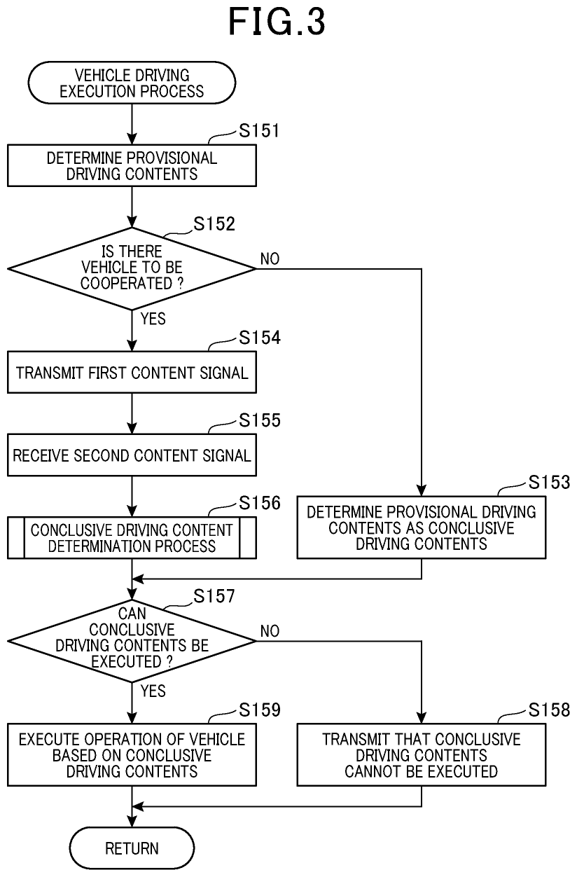

When the vehicle driving execution process (step S150) shown in FIG. 3 is activated, the first determination unit 410 in the control unit 400 determines provisional driving contents which are the driving contents of the automatic driving vehicle 50 according to the instruction signals (step S151).

After determination of the provisional driving contents (step S151), the control unit 400 decides whether there is a vehicle to be cooperated when the automatic driving vehicle 50 executes the provisional driving contents (step S152). In this embodiment, the control unit 400 uses information acquired by the vehicle-mounted camera 110 and the LIDAR 120 to decide whether there is a vehicle from which cooperation is required when the automatic driving vehicle 50 executes the provisional driving contents. As used herein, the “vehicle to be cooperated when the automatic driving vehicle 50 executes the provisional driving contents” is a vehicle present in a course region when the automatic driving vehicle 50 executes the provisional driving contents.

When it is decided that there is no vehicle from which cooperation is required when the automatic driving vehicle 50 executes the provisional driving contents (steps S152: NO), the second determination unit 420 in the control unit 400 determines the provisional driving contents as the conclusive driving contents (step S153).

When deciding that there is a vehicle from which cooperation is required when the automatic driving vehicle 50 executes the provisional driving contents (step S152: YES), the control unit 400 controls the first transmission unit 315 to transmit first content signals to any other automatic driving vehicle (step S154). The first content signals indicate the driving contents indicated by the received instruction signals and the provisional driving contents.

After transmission of the first content signals (step S154), the second receiving unit 320 receives, from the other automatic driving vehicle, second content signals indicating the driving contents to be executed by the other automatic driving vehicle upon reception of the first content signals (step S155).

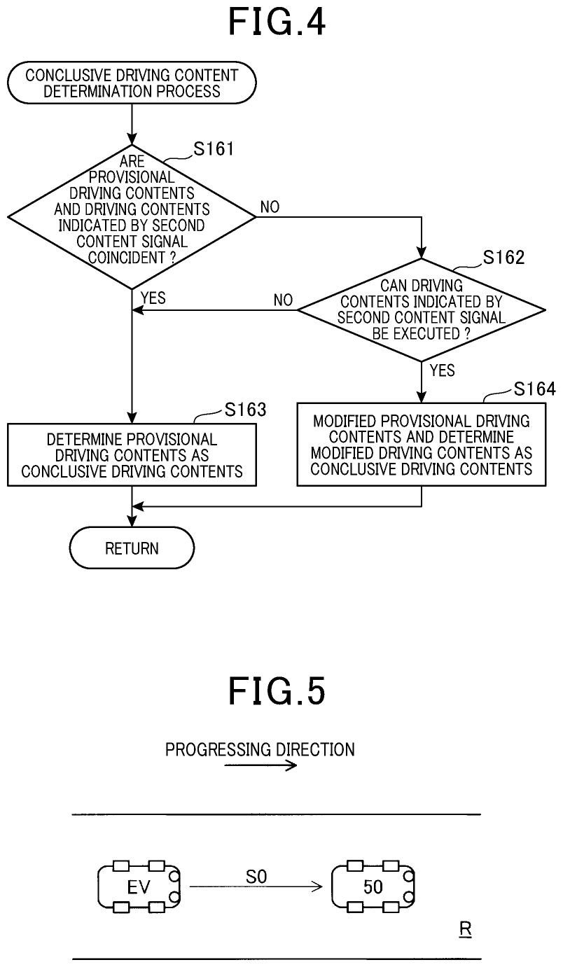

After reception of the second content signals by the second receiving unit 320 (step S155), the second determination unit 420 in the control unit 400 performs a conclusive driving content determination process for determining the conclusive driving contents according to the driving contents indicated by the instruction signals and the driving contents indicated by the second content signals (step S156). The conclusive driving contents are driving contents of the automatic driving vehicle 50 to be executed finally. The details of the conclusive driving content determination process (step S156) will be described with reference to FIG. 4.

### A4. Conclusive Driving Content Determination Process:

The conclusive driving content determination process shown in FIG. 4 involves determining the provisional driving contents as conclusive driving contents (step S163) when the provisional driving contents and the driving contents indicated by the second content signals match with each other (step S161: YES). When the provisional driving contents and the driving contents indicated by the second content signals are not coincident with each other (step S161: NO), when the driving contents indicated by the second content signals can be executed (step S162: YES), the provisional driving contents are modified to the driving contents indicated by the second content signals, and the modified driving contents are determined as the conclusive driving contents (step S164). When the driving contents indicated by the second content signals cannot be executed (step S162: NO), the provisional driving contents are determined as the conclusive driving contents (step S163). Incidentally, whether the driving contents indicated by the second content signals can be or cannot be executed is decided using the information acquired by the vehicle-mounted camera 110 and the LIDAR 120.

Returning to FIG. 3, after the conclusive driving content determination process (step S156), the control unit 400 decides whether the conclusive driving contents can be executed (step S157). Specifically, the control unit 400 uses the information acquired by the vehicle-mounted camera 110 and the LIDAR 120 to decide whether the conclusive driving contents can be executed. The information mainly used here is information on the peripheral environment of the automatic driving vehicle 50 acquired by the vehicle-mounted camera 110 and the LIDAR 120, which corresponds to the presence or absence of an obstacle, for example. When the conclusive driving contents cannot be executed due to the presence of an obstacle or the like, the control unit 400 decides that the conclusive driving contents cannot be executed. The decision on the possibility of execution may differ between when the automatic driving vehicle 50 executes normal automatic driving and when the automatic driving vehicle 50 executes automatic driving according to the instruction signals. For example, when the automatic driving vehicle 50, while stopping at a stop line at an intersection, receives an instruction signal for instructing the movement in the right, left or front direction from the stop line, the control unit 400 may decide that the movement of the automatic driving vehicle 50 beyond the stop line to a position where it does not hinder passage of other vehicles can be executed. Also, the control unit 400 may decide that such movement cannot be executed when the automatic driving vehicle 50 is under normal automatic driving.

When deciding that the conclusive driving contents cannot be executed (step S157: NO), the control unit 400 transmits, to the emergency vehicle which has output the instruction signals, information that the automatic driving of the automatic driving vehicle 50 according to the instruction signals cannot be executed (step S158). Then, the control unit 400 terminates the vehicle driving execution process (step S150).

When deciding that the conclusive driving contents can be executed (step S157: YES), the control unit 400 executes the automatic driving of the automatic driving vehicle 50 based on the conclusive driving contents (step S159). Then, the control unit 400 terminates the automatic driving control process, as shown in FIG. 2.

In FIG. 5, an emergency vehicle EV and an automatic driving vehicle 50 are traveling from the left side toward the right side on a road R. The automatic driving vehicle 50 in FIG. 5 is under automatic driving.

In the example in FIG. 5, the driving contents indicated by an instruction signal S0 output from the emergency vehicle EV are intended for instructions to drive so as to “create the course for passage of the emergency vehicle EV”. According to the instruction signal S0, the first determination unit 410 in the automatic driving vehicle 50 determines, as provisional driving contents, movement of the automatic driving vehicle 50 toward the left side in the progressing direction on the road R.

In this embodiment, the priority of the criteria for selection of the progressing directions determined, by the first determination unit 410, as the provisional driving contents in response to the request “to create the course for passage of the emergency vehicle EV” by the instruction signal S0 is as follows. Depending on the positional relationship between the vehicle which outputs the instruction signal indicating the request and the automatic driving vehicle 50, the priority of the criteria for selection of the progressing directions varies. The progressing directions are listed in descending order of the priority in each of the positional relationships. For example, in the case where a request is made from a rear vehicle to the automatic driving vehicle 50, the progressing direction with the highest priority is a front road shoulder direction, and the progressing direction with the lowest priority is rear straight-ahead.
In the case where a request is made from a rear vehicle to the automatic driving vehicle 50: front road shoulder direction, front roadway centerline direction, front straight-ahead, rear road shoulder direction, rear roadway centerline direction, and rear straight-ahead.
In the case where a request is made from a right, left or front vehicle to the automatic driving vehicle 50 (at an intersection or the like): rear straight-ahead, rear road shoulder direction, rear roadway centerline direction, front straight-ahead, front road shoulder direction, and front roadway centerline direction.
In the case where a request is made from a right, left or rear vehicle to the automatic driving vehicle 50 (at an intersection or the like): front straight-ahead, front road shoulder direction, front roadway centerline direction, rear straight-ahead, rear road shoulder direction, and rear roadway centerline direction.
In the case where a request is made from a front vehicle to the automatic driving vehicle 50: rear road shoulder direction, rear roadway centerline direction, rear straight-ahead, front road shoulder direction, front roadway centerline direction, and front straight-ahead.

The automatic driving vehicle 50 receives the instruction signal S0, the provisional driving contents are determined to be “movement to the left side in the progressing direction on the road R” which corresponds to the front road shoulder direction, and, thereafter, it is decided that there is no vehicle to be cooperated when the automatic driving vehicle 50 executes the provisional driving contents. So, the provisional driving contents are determined as the conclusive driving contents.

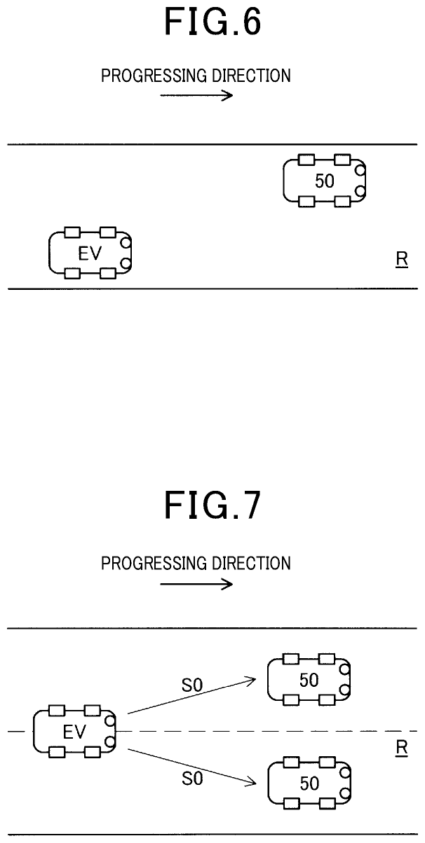

Then, the control unit 400 decides that the conclusive driving contents can be executed, and then executes the automatic driving of the automatic driving vehicle 50 based on the conclusive driving contents of moving the automatic driving vehicle 50 toward the left side in the progressing direction. As a result, the automatic driving vehicle 50 moves toward the left side in the progressing direction on the road R, as shown in FIG. 6. The emergency vehicle EV can progress on the right side in the progressing direction on the road R, which has been cleared by the movement of the automatic driving vehicle 50.

In FIG. 7, the emergency vehicle EV and two automatic driving vehicles 50 are traveling from the left side toward the right side on a road R in FIG. 7. The automatic driving vehicles 50 in FIG. 7 are under automatic driving. The broken line in the center portion of the road R in FIG. 7 represents a centerline.

In the example in FIG. 7, the driving contents indicated by the instruction signal S0 output from the emergency vehicle EV are intended for instructions to drive so as to “create a course for passage of the emergency vehicle EV”, as is the case with FIG. 5. According to the instruction signal S0, the first determination unit 410 in each of the automatic driving vehicles 50 determines, as provisional driving contents, movement of the automatic driving vehicle 50 toward the front road shoulder direction on the road R. At this time, it is decided that there is no vehicle from which cooperation is required when the provisional driving contents are executed in each of the automatic driving vehicles 50, and thus the provisional driving contents are determined as the conclusive driving contents.

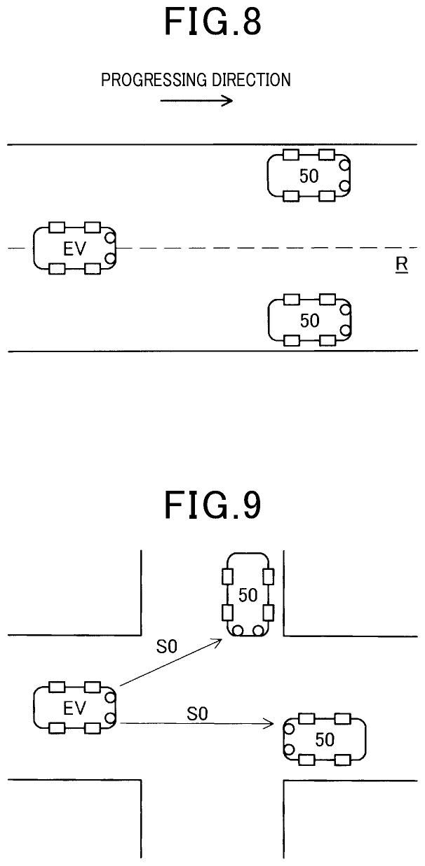

Then, the control unit 400 decides that the conclusive driving contents can be executed, and then executes the automatic driving of each of the automatic driving vehicles 50 based on the conclusive driving contents of moving the automatic driving vehicle 50 toward the front road shoulder direction. As a result, each of the automatic driving vehicles 50 moves toward the front road shoulder direction on the road R, as shown in FIG. 8. The emergency vehicle EV can progress around the centerline on the road R, which has been cleared by the movement of the automatic driving vehicle 50. The driving contents indicated by the instruction signal S0 output from the emergency vehicle EV are intended for instructions to “create a course for passage of the emergency vehicle EV” in the description in FIG. 7, but are not limited thereto, and may be, for example, instructions to “clear a region around the centerline”.

In an example of FIG. 9, the emergency vehicle EV and two automatic driving vehicles 50 are present at an intersection. In the example in FIG. 9, the driving contents indicated by the instruction signal S0 output from the emergency vehicle EV are intended for instructions to drive so as to “stop at the current location until the emergency vehicle EV passes the intersection”. As is the case with the processes of the automatic driving vehicle 50 described in FIGS. 5 to 8, the automatic driving of the two automatic driving vehicles 50 is executed based on the conclusive driving contents of stopping at the current location until the emergency vehicle EV passes the intersection, in the example in FIG. 9.

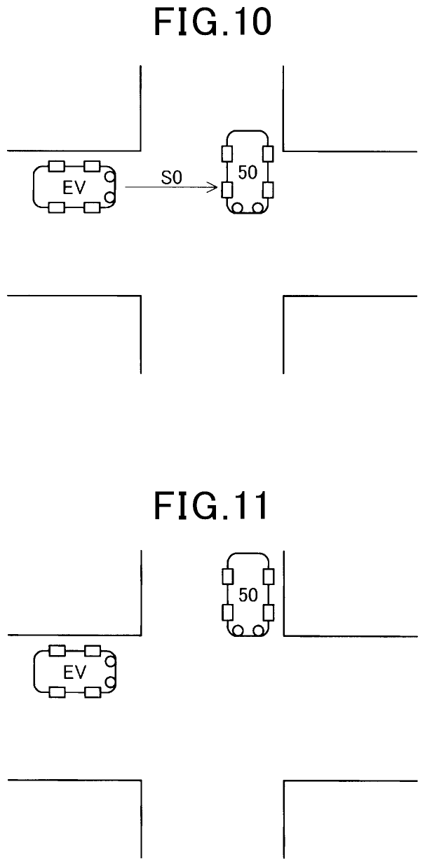

In an example of FIG. 10, the emergency vehicle EV and one automatic driving vehicle 50 are present while stopping at an intersection. In the example in FIG. 10, the driving contents indicated by the instruction signal S0 output from the emergency vehicle EV are intended for instructions to drive so as to “create the course for passage of the emergency vehicle EV”. In the example in FIG. 10, the automatic driving of the automatic driving vehicle 50 is executed based on the conclusive driving contents of moving the automatic driving vehicle 50 toward the rear side in the progressing direction in order to create the course for passage of the emergency vehicle EV. As a result, the automatic driving vehicle 50 moves toward the rear side in the progressing direction at the intersection, as shown in FIG. 11.

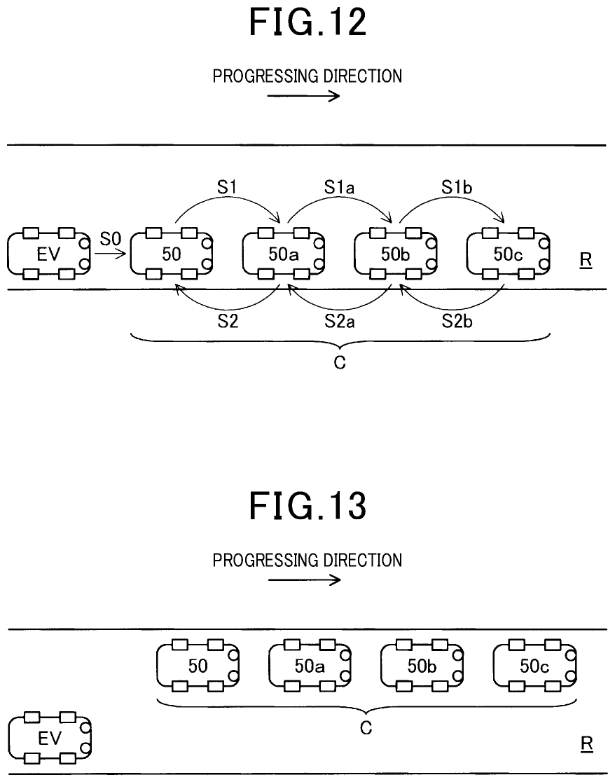

In an example shown in FIG. 12, the instruction signal S0 is output from the emergency vehicle EV to the automatic driving vehicle 50 traveling at the tail end of a platoon C traveling following preceding vehicles. Automatic driving vehicles 50a, 50b, 50c which form the platoon C are equipped with the automatic driving control device 10, similarly to the automatic driving vehicle 50. In FIG. 12, the emergency vehicle EV and the automatic driving vehicles 50, 50a, 50b, 50c are progressing from the left side toward the right side in FIG. 12. The automatic driving vehicles 50, 50a, 50b, 50c are each under automatic driving.

In the case of FIG. 12, the driving contents indicated by the instruction signal S0 output from the emergency vehicle EV are intended for instructions to drive so as to “create a course for passage of the emergency vehicle EV”. The first determination unit 410 in the automatic driving control device 10 mounted in the automatic driving vehicle 50 determines provisional driving contents according to the instruction signal S0. The provisional driving contents determined at this time are “movement toward the left side in the progressing direction on the road R”. Since the automatic driving vehicle 50a is present around the automatic driving vehicle 50 as the vehicle to be cooperated when the automatic driving vehicle 50 executes the provisional driving contents, a first content signal S1 is transmitted to the automatic driving vehicle 50a. The first content signal 51 indicates the driving contents indicated by the received instruction signal S0 and the provisional driving contents of the automatic driving vehicle 50.

When the first content signal S1 is transmitted to the automatic driving vehicle 50a from the automatic driving vehicle 50, the automatic driving vehicle 50a determines the provisional driving contents of the automatic driving vehicle 50a according to the first content signal S1. Then, as is the case with transmission of the first content signal 51, a content signal S1a indicating the driving contents indicated by the instruction signal S0 and the provisional driving contents of the automatic driving vehicles 50 and 50a is transmitted from the automatic driving vehicle 50a toward the automatic driving vehicle 50b. When the automatic driving vehicle 50b receives the content signal S1a, the automatic driving vehicle 50b determines the provisional driving contents of the automatic driving vehicle 50b according to the content signal S1a. Then, as is the case with transmission of the content signal S1a, a content signal S1b indicating the driving contents indicated by the instruction signal S0 and the provisional driving contents of the automatic driving vehicles 50, 50a and 50b is transmitted from the automatic driving vehicle 50b toward the automatic driving vehicle 50c.

When the automatic driving vehicle 50c, which is the leading vehicle of the platoon C, receives the content signal S1b, the automatic driving vehicle 50c determines conclusive driving contents to be executed by the automatic driving vehicle 50c according to the content signal S1b. A content signal S2b indicating the conclusive driving contents to be executed by the automatic driving vehicle 50c is transmitted from the automatic driving vehicle 50c toward the automatic driving vehicle 50b. The automatic driving vehicle 50b determines conclusive driving contents to be executed by the automatic driving vehicle 50b according to the driving contents indicated by the instruction signal S0 and the conclusive driving contents indicated by the received content signal S2b. Then, a content signal S2a indicating the conclusive driving contents to be executed by the automatic driving vehicle 50b is transmitted from the automatic driving vehicle 50b toward the automatic driving vehicle 50a. The automatic driving vehicle 50a determines conclusive driving contents to be executed by the automatic driving vehicle 50a according to the driving contents indicated by the instruction signal S0 and the conclusive driving contents indicated by the received content signal S2a. Then, a second content signal S2 indicating the conclusive driving contents to be executed by the automatic driving vehicle 50a is transmitted from the automatic driving vehicle 50a toward the automatic driving vehicle 50.

The automatic driving vehicle 50 receives the second content signal S2. The second determination unit 420 determines conclusive driving contents which are the driving contents of the automatic driving vehicle 50 according to the conclusive driving contents indicated by the second content signal S2 and the driving contents indicated by the instruction signal S0. As used herein, the “determining the conclusive driving contents according to the driving contents indicated by the second content signal S2 and the contents indicated by the instruction signal S0” means determining the driving contents of the automatic driving vehicle 50 effective for realizing the contents indicated by the instruction signal S0 as the conclusive driving contents in consideration of the driving contents indicated by the second content signal S2 in this embodiment. In FIG. 12, the conclusive driving contents of the automatic driving vehicle 50a indicated by the second content signal S2 are “movement toward the left side in the progressing direction on the road R”. At this time, the provisional driving contents preliminarily determined in the automatic driving vehicle 50 are “movement toward the left side in the progressing direction on the road R”, and thus the provisional driving contents and the driving contents indicated by the second content signal S2 are coincident with each other. Therefore, since the provisional driving contents are determined as the conclusive driving contents, the determination at this time corresponds to step S163 from step S161: YES in FIG. 4.

Also, in this embodiment, the control unit 400 of the automatic driving vehicle 50 executes the automatic driving of the automatic driving vehicle 50 based on the conclusive driving contents almost in sync with the execution of the automatic driving of the automatic driving vehicle 50a upon reception of the first content signal S1 by communication with the automatic driving vehicle 50a via the communication unit 300. Such communication may be made between the other automatic driving vehicles constituting the platoon C.

As shown in FIG. 13, after exchange of the signals S1, S2, S1a, S2b, S1a, S2b described in the example in FIG. 12 is made between the respective automatic driving vehicles of the automatic driving vehicle group constituting the platoon C, the respective automatic driving vehicles constituting the platoon C execute the automatic driving according to the instruction signal S0 output from the emergency vehicle EV. In FIG. 13, the respective automatic driving vehicles move almost at once toward the left side in the progressing direction on the road R.

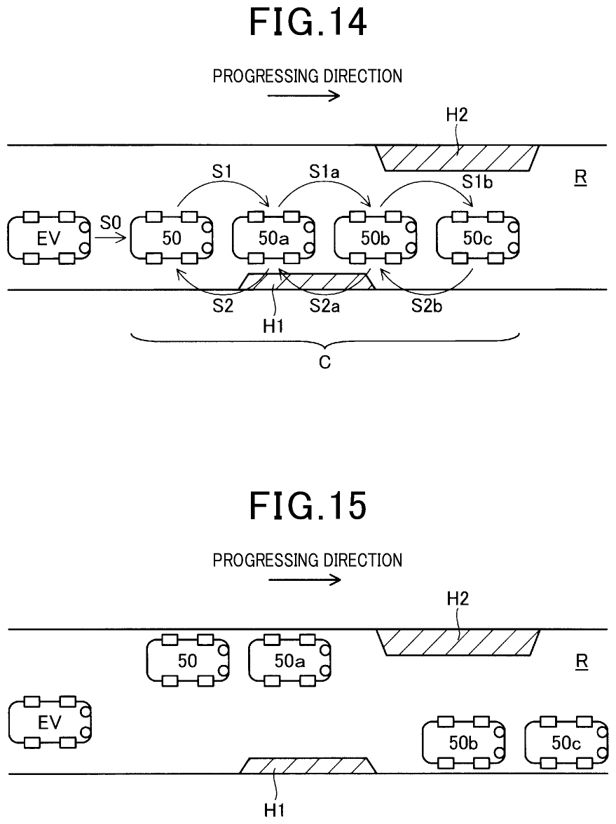

In FIG. 14, the automatic driving vehicles 50, 50a, 50b, 50c are under automatic driving. The hatched parts in FIG. 14 represent obstacles H1 and H2. The obstacle H1 is present on the right side in the progressing direction on the road R. The obstacle H2 is present on the left side in the progressing direction on the road R. In the portions where the obstacles H1, H2 are present, the road width is narrowed. Also, in the case of FIG. 14, the driving contents indicated by the instruction signal S0 output from the emergency vehicle EV are intended for instructions to drive so as to “create the course for passage of the emergency vehicle EV”. In FIG. 14, an explanation will be given about an example in which the respective automatic driving vehicles constituting the platoon C execute different driving contents, unlike the example in FIG. 12 in which the respective automatic driving vehicles constituting the platoon C execute the same driving contents.

Similarly to the exchange of the signals between the respective platooning automatic driving vehicles described in FIG. 12, the respective automatic driving vehicles in FIG. 14 also exchange signals. In FIG. 14, the driving contents to be executed finally by automatic driving vehicles 50 and 50a, i.e., the conclusive driving contents are “movement toward the left side in the progressing direction on the road R”. On the other hand, the automatic driving vehicle 50b cannot execute the “movement toward the left side in the progressing direction on the road R” due to the presence of the obstacle H2 and cannot execute the “movement toward the right side in the progressing direction on the road R” due to the presence of the obstacle H1. However, the obstacle H1 will be eliminated on the right side in the progressing direction of the automatic driving vehicle 50b by straight-ahead movement. So, the automatic driving vehicle 50b transmits, to the automatic driving vehicle 50c, the content signal S1b indicating “straight-ahead movement followed by movement toward the right side in the progressing direction on the road R” as provisional driving contents. The automatic driving vehicle 50c determines conclusive driving contents to be executed by the automatic driving vehicle 50c as the “straight-ahead movement followed by movement toward the right side in the progressing direction on the road R” according to the received content signal S1b. Then, the automatic driving vehicle 50b can determine the conclusive driving contents to be executed by the automatic driving vehicle 50b as the “straight-ahead movement followed by movement toward the right side in the progressing direction on the road R” according to the received content signal S2b.

As shown in FIG. 15, after exchange of the signals described in the example in FIG. 14 are made between the respective automatic driving vehicles of the automatic driving vehicle group constituting the platoon C, the automatic driving vehicles 50 and 50a execute the “movement toward the left side in the progressing direction on the road R” as the conclusive driving contents, and the automatic driving vehicles 50b and 50c execute the “straight-ahead movement followed by movement toward the right side in the progressing direction on the road R” as the conclusive driving contents, so that the course for passage of the emergency vehicle EV is created.

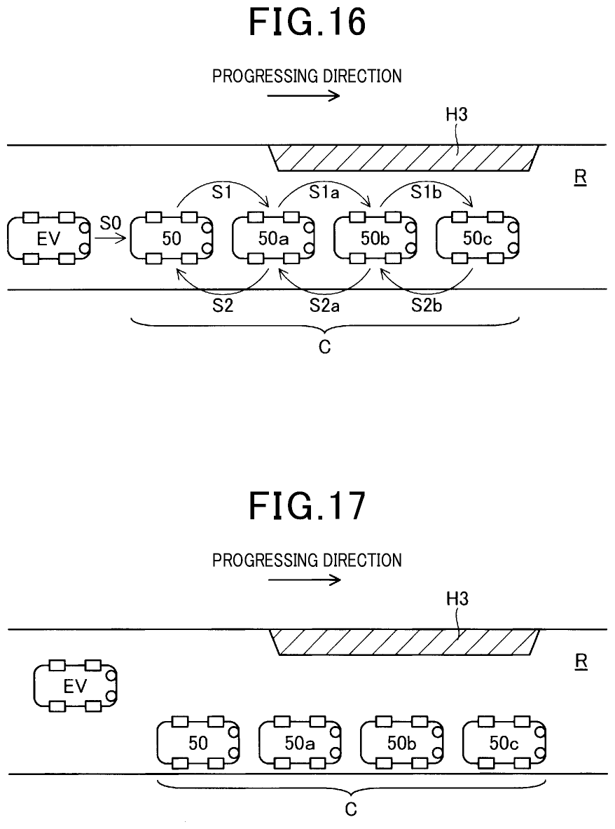

In FIG. 16, the automatic driving vehicles 50, 50a, 50b, 50c are under automatic driving. The hatched part in FIG. 16 represents an obstacle H3. The obstacle H3 is present on the left side in the progressing direction on the road R. In the portions where the obstacle H3 is present, the road width is narrowed. Also, in the case of FIG. 16, the driving contents indicated by the instruction signal S0 output from the emergency vehicle EV are intended for instructions to drive so as to “create the course for passage of the emergency vehicle EV”. In FIG. 16, an explanation will be given about an example in which the provisional driving contents that have been preliminarily determined in the automatic driving vehicle 50 are modified and the modified provisional driving contents are determined as the conclusive driving contents, unlike the examples in FIGS. 12 to 15 in which the provisional driving contents that have been preliminarily determined in the automatic driving vehicle 50 are determined as the conclusive driving contents without any modification.

Similarly to the exchange of the signals between the respective platooning automatic driving vehicles described in FIGS. 12 and 14, the respective automatic driving vehicles in FIG. 16 also exchange signals. In FIG. 16, the driving contents determined as the provisional driving contents of the automatic driving vehicle 50 are “movement toward the left side in the progressing direction on the road R”. However, the driving contents determined as the conclusive driving contents of the automatic driving vehicles 50a, 50b, 50c are “movement toward the right side in the progressing direction on the road R” due to the presence of the obstacle H3. Thus, the provisional driving contents and the driving contents indicated by the second content signal S2 are not coincident with each other. At this time, the following process is performed as the conclusive driving content determination process in FIG. 4 in the automatic driving control device 10 in the automatic driving vehicle 50. Specifically, since the provisional driving contents and the driving contents indicated by the second content signal S2 are not coincident with each other (step S161: NO), and the “movement toward the right side in the progressing direction on the road R”, as the driving contents indicated by the second content signal S2, can be executed (step S162: YES), the provisional driving contents are modified to the driving contents indicated by the second content signal S2, and the modified driving contents are determined as the conclusive driving contents. The determination at this time corresponds to step S164 in FIG. 4.

As shown in FIG. 17, after exchange of the signals described in the example in FIG. 16 are made between the respective automatic driving vehicles of the automatic driving vehicle group constituting the platoon C, the automatic driving vehicles 50, 50a, 50b, 50c execute the “movement toward the right side in the progressing direction on the road R” as the conclusive driving contents, so that the course for passage of the emergency vehicle EV is created.

The automatic driving control device 10 of the first embodiment described above makes it possible to execute proper automatic driving using the provisional driving contents determined according to instruction signal S0 indicating the driving contents even when the automatic driving vehicle 50 receives the instruction signal S0 during automatic driving. Here, the wording “using the provisional driving contents” will be described. Since there is no vehicle to be cooperated when the automatic driving vehicle 50 executes the provisional driving contents in the examples in FIGS. 5 to 11, the provisional driving contents are used in the determination of the provisional driving contents as the conclusive driving contents. Since there are vehicles to be cooperated when the automatic driving vehicle 50 executes the provisional driving contents in the examples in FIGS. 12 to 17, the provisional driving contents are used in the determination of the conclusive driving contents based on the driving contents indicated by the second content signal S2 transmitted from the other automatic driving vehicle which has received the first content signal 51 including the provisional driving contents. As can be understood from these examples, in the automatic driving control device 10, the provisional driving contents can be used to execute the automatic driving of the automatic driving vehicle 50.

In the automatic driving control device 10, in the case where there is a vehicle to be cooperated when the automatic driving vehicle 50 executes the provisional driving contents, signal exchange of the automatic driving vehicle 50 with the other automatic driving vehicles is made via the first transmission unit 315 and the second receiving unit 320, and the second determination unit 420 determines the conclusive driving contents. Therefore, the automatic driving of the automatic driving vehicle 50 can be executed based on the conclusive driving contents determined according to the driving contents of the other automatic driving vehicles and the contents of the instruction signal S0.

Also, in the automatic driving control device 10, the control unit 400 executes the automatic driving of the automatic driving vehicle 50 based on the conclusive driving contents in sync with the execution of the automatic driving of the automatic driving vehicle 50a by communication with the automatic driving vehicle 50a via the communication unit 300. Therefore, the automatic driving of the automatic driving vehicle 50 is executed in sync with the execution of the automatic driving of the other automatic driving vehicle 50a, so that the automatic driving vehicles can be cooperated smoothly.

### Second Embodiment

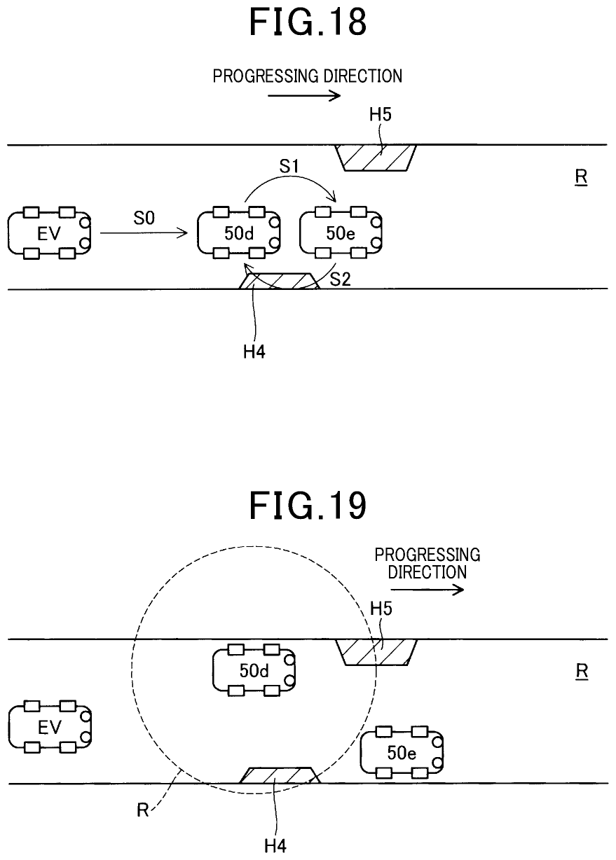

In FIG. 18, the instruction signal S0 is output from the emergency vehicle EV to an automatic driving vehicle 50d equipped with an automatic driving control device 10d in a second embodiment. The automatic driving control device 10d of the second embodiment is different from the automatic driving control device 10 of the first embodiment in that the control unit 400 in the automatic driving control device 10d, when executing the automatic driving of the automatic driving vehicle 50d based on the conclusive driving contents in sync with the execution of automatic driving of other automatic driving control vehicles adjusts the position of the automatic driving vehicle 50d relative to the other automatic driving vehicles so that the other automatic driving vehicles are positioned outside a range set on the basis of the automatic driving vehicle 50d as a reference, depending on the conditions.

In FIG. 18, automatic driving vehicles 50d and 50e are under automatic driving. The hatched parts in FIG. 18 represent obstacles H4 and H5. The obstacle H4 is present on the right side in the progressing direction on the road R. The obstacle H5 is present on the left side in the progressing direction on the road R. In the portions where the obstacles H4, H5 are present, the road width is narrowed. Also, in the case of FIG. 18, the driving contents indicated by the instruction signal S0 output from the emergency vehicle EV are intended for instructions to drive so as to “create a course for passage of the emergency vehicle EV”.

In FIG. 18, the driving contents determined as the conclusive driving contents of the automatic driving vehicle 50d are “movement toward the left side in the progressing direction on the road R”. Also, the conclusive driving contents of the automatic driving vehicle 50e are “to move toward the right side in the progressing direction on the road R”. At this time, the following process is performed as the conclusive driving content determination process in FIG. 4 in the automatic driving vehicle 50d. Specifically, since the “movement toward the left side in the progressing direction on the road R” which are the driving contents determined as the provisional driving contents and the “movement toward the right side in the progressing direction on the road R” which are the conclusive driving contents indicated by the second content signal S2 are not coincident with each other (step S161: NO), and the driving contents indicated by the second content signal S2 cannot be executed (step S162: NO), the provisional driving contents are determined as the conclusive driving contents (step S163). So, the conclusive driving contents of the automatic driving vehicle 50d are “movement toward the left side in the progressing direction on the road R”. At this time, the control unit 400 of the automatic driving control device 10d mounted in the automatic driving vehicle 50d executes the automatic driving of the automatic driving vehicle 50d based on the conclusive driving contents in sync with the execution of the automatic driving of the automatic driving vehicle 50e by communication with the automatic driving vehicle 50e via the communication unit 300.

The automatic driving vehicles 50d and 50e according to the instruction signal S0 in FIG. 19 are in a state after execution of their automatic driving. When the driving contents to be executed by the automatic driving vehicle 50d are traveling in either one of the right and left directions, the driving contents to be executed by the automatic driving vehicle 50e are traveling in the other of the right and left directions, which is different from that of the automatic driving vehicle 50d, and the control unit 400 in the automatic driving control device 10d of the second embodiment executes the automatic driving of the automatic driving vehicle 50d in sync with the execution of the automatic driving of the other automatic driving vehicle 50e, in the case where the automatic driving vehicle 50e is present within a range R set on the basis of the automatic driving vehicle 50d as a reference, the control unit 400 adjusts the position of the automatic driving vehicle 50d relative to the automatic driving vehicle 50e so that the automatic driving vehicle 50e is positioned outside the range R.

The range R is a circular range around the automatic driving vehicle 50d. In a state where the automatic driving vehicle 50e is positioned outside the range R, the range is set so that the emergency vehicle EV can pass between the automatic driving vehicles 50d and 50e. The range R is not limited to the circular range, and may be in another shape such as a rectangular shape. The “adjusting the position of the automatic driving vehicle 50d relative to the automatic driving vehicle 50e so that the automatic driving vehicle 50e is positioned outside the range R” may be realized by adjusting only the position of the automatic driving vehicle 50d. Or, such adjustment may be realized by adjusting only the position of the automatic driving vehicle 50e through communication between the automatic driving vehicles 50d and 50e, or by adjusting the positions of both the automatic driving vehicles 50d and 50e.

According to the second embodiment described above, it is possible to more reliably ensure the course for passage of the vehicle that has output the instruction signal for requesting the automatic driving vehicles to give way, as compared with the form in which the position of the automatic driving vehicle 50d relative to the automatic driving vehicle 50e is not adjusted so that the automatic driving vehicle 50e is positioned outside the range R.

### Third Embodiment

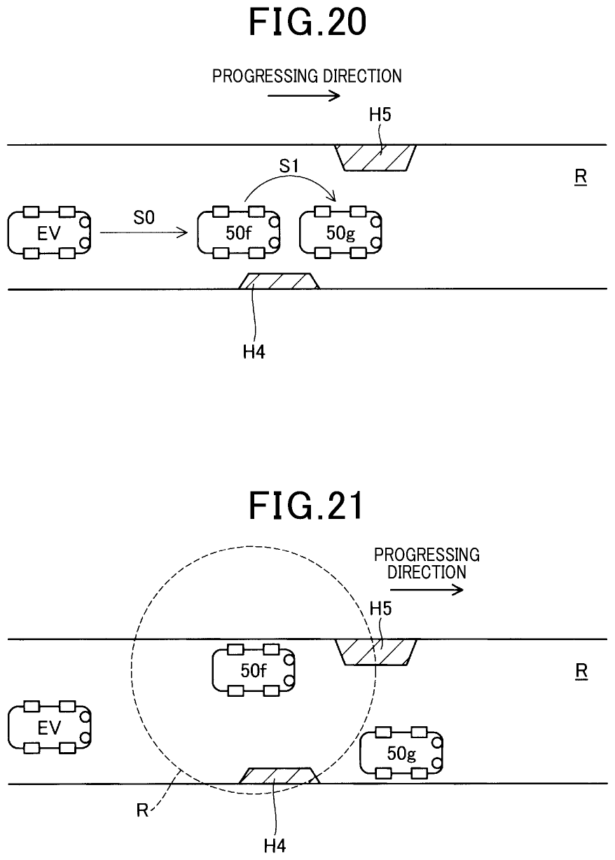

In FIG. 20, the instruction signal S0 is output from the emergency vehicle EV to an automatic driving vehicle 50f equipped with an automatic driving control device 10f in a third embodiment. The automatic driving control device 10f of the third embodiment is different from the automatic driving control device 10 of the first embodiment in that it does not include the second receiving unit 320 or the second determination unit 420. The automatic driving control device 10f of the third embodiment is different from the automatic driving control device 10 of the first embodiment also in that it transmits the first content signal S1 to surrounding automatic driving control vehicles regardless of whether there is a vehicle to be cooperated when the automatic driving vehicle 50f executes provisional driving contents after reception of the instruction signal and determination of the provisional driving contents, and that the automatic driving of the automatic driving vehicle 50f is executed based on the provisional driving contents as the conclusive driving contents. Further, the automatic driving control device 10f of the third embodiment is different from the automatic driving control device 10 of the first embodiment in that, when automatic driving is executed based on the provisional driving contents, the provisional driving contents to be executed by the automatic driving vehicle 50f are traveling in either one of the right and left directions upon reception of the first content signals, the driving contents to be executed by any other automatic driving vehicle upon reception of the first content signal S1 are traveling in the other of the right and left directions, which is different from that of the automatic driving vehicle 50f, and the other automatic driving vehicle each execute the automatic driving, in the case where any other automatic driving vehicle is present within the range set on the basis of the automatic driving vehicle 50f as a reference, it adjusts the position of the automatic driving vehicle 50f relative to the other automatic driving vehicle so that the other automatic driving vehicle is positioned outside the range.

In FIG. 20, automatic driving vehicles 50f and 50g are under automatic driving. The hatched parts in FIG. 20 represent obstacles H4 and H5. The obstacles H4 and H5 are identical with the obstacles H4 and H5 in FIGS. 18 and 19. Also, in the case of FIG. 20, the driving contents indicated by the instruction signal S0 output from the emergency vehicle EV are intended for instructions to drive so as to “create the course for passage of the emergency vehicle EV”. In FIG. 20, the driving contents to be executed as the provisional driving contents of the automatic driving vehicle 50f are instructions “to move toward the left side in the progressing direction on the road R”. The automatic driving vehicle 50f equipped with the automatic driving control device 10f of the third embodiment transmits the first content signal S1 to the surroundings regardless of whether there is a vehicle to be cooperated when the automatic driving vehicle 50f executes provisional driving contents, and the automatic driving of the automatic driving vehicle 50f is executed based on the provisional driving contents as the conclusive driving contents. In FIG. 20, the driving contents to be executed by the automatic driving vehicle 50g upon reception of a first content signal S1 is “movement toward the right side in the progressing direction on the road R”.

The automatic driving vehicles 50f and 50g according to the instruction signal S0 in FIG. 21 are in a state after execution of their automatic driving. When the automatic driving vehicles 50f and 50g execute automatic driving due to the fact that the automatic driving vehicle 50f receives the instruction signal S0, in the case where there is another automatic driving vehicle 50g within a range R set on the basis of the automatic driving vehicle 50f as a reference, the control unit 400 in the automatic driving control device 10f of the third embodiment adjusts the position of the automatic driving vehicle 50f relative to the other automatic driving vehicle 50g so that the automatic driving vehicle 50g is positioned outside the range R

The range R is identical with the range R described in FIG. 19. Also in FIG. 20, the range R is not limited to being a circular range, and may be in another shape such as a rectangular shape. The “adjusting the position of the automatic driving vehicle 50f relative to the automatic driving vehicle 50g so that the automatic driving vehicle 50g is positioned outside the range R” may be realized by adjusting only the position of the automatic driving vehicle 50d. Alternatively, such adjustment may be realized by adjusting the position of the automatic driving vehicle 50 g which has received the first content signal S1 relative to the automatic driving vehicle 50f, or by adjusting the positions of both the automatic driving vehicles 50f and 50g.

According to the third embodiment described above, it is possible to more reliably ensure the course for passage of the vehicle that has output the instruction signal for requesting the automatic driving vehicles to give way, as compared with the form in which the position of the automatic driving vehicle 50f relative to the automatic driving vehicle 50g is not adjusted so that the automatic driving vehicle 50g is positioned outside the range R.

### Other Embodiments

(1) When the automatic driving vehicle 50 receives a plurality of instruction signals during execution of automatic driving, the control unit 400 of the automatic driving control device 10 in the first embodiment may execute the automatic driving of the automatic driving vehicle 50 using the provisional driving contents determined according to the instruction signals, in accordance with preset priority, in descending order of the priority. For the “preset priority” as used herein, the priority may be set to be higher as the distance from the subject which has output the instruction signals is shorter. Also, the priority may be set to be higher as the instruction signals are output including the reason for request with higher urgency. According to such a form, it is possible to execute automatic driving corresponding to each of the instruction signals even when the automatic driving vehicle 50 receives a plurality of instruction signals during automatic driving.

(2) The communication unit 300 of the automatic driving control device 10 in the first embodiment further has a second transmission unit that transmits a preset signal to the other automatic driving vehicles, and the control unit 400 may allow the second transmission unit to transmit the preset signal, and then execute the automatic driving of the automatic driving vehicles based on the conclusive driving contents. Here, the “preset signal” is a signal which is transmitted to notify the automatic driving vehicle 50a that the second receiving unit 320 has received the second content signal S2. According to such a form, the conclusive driving contents are executed after the other automatic driving vehicles receive the preset signal, thereby making it possible to prevent occurrence of a cooperation gap among the automatic driving vehicles due to the disturbance of the signal exchange by noise or the like.

(3) The communication unit 300 of the automatic driving control device 10 in the first embodiment may further have an information acquisition unit that communicates with other automatic driving vehicles to acquire identification information on the other automatic driving vehicles. According to such a form, when the first transmission unit 315 transmits the first content signal S1, it transmits the first content signal S1 together with the identification information of the preliminarily acquired identification information on the other automatic driving vehicles, so that the other automatic driving vehicle which has received the first content signal S1 can confirm that the transmission destination of the first content signal S1 is itself using the identification information. Therefore, it is possible to prevent cooperation of another automatic driving vehicle which has erroneously received the first content signal S1 with the automatic driving vehicle 50 which has transmitted the first content signal S1.

(4) The automatic driving control device 10 in the first embodiment, when deciding that there is a vehicle to be cooperated when the automatic driving vehicle 50 executes the provisional driving contents (step S152: YES), transmits the first content signal to the other automatic driving vehicle (step S154). However, the present disclosure is not limited to this. For example, when the provisional driving contents are determined (step S151), the automatic driving control device 10 may either transmit the first content signal to the surroundings of the automatic driving vehicle 50 (for example, a range within 10 m radius around the automatic driving vehicle 50) without deciding whether there is a vehicle to be cooperated when the automatic driving vehicle 50 executes the provisional driving contents, and determine the provisional driving contents as the conclusive driving contents according to whether the second content signal is received within a preset period of time (step S153), or determine the conclusive driving contents according to the driving contents indicated by the second content signal and the contents of the instruction signal (step S156).

(5) In the automatic driving control device 10 in the first embodiment, the control unit 400 executes the automatic driving of the automatic driving vehicle 50 based on the conclusive driving contents. However, the present disclosure is not limited to this. For example, when the conclusive driving contents are determined, the automatic driving control device 10 may transfer the driving of the automatic driving vehicle 50 to the passenger of the automatic driving vehicle 50.

(6) In the automatic driving control device 10 in the first embodiment, when the automatic driving vehicle 50 is under automatic driving after reception of the instruction signal (step S130: YES), the control unit 400 performs the vehicle driving execution process (step S150). However, the present disclosure is not limited to this. For example, even when the automatic driving vehicle 50 is under automatic driving after reception of the instruction signal (step S130: YES), the automatic driving control device 10 may announce the contents of the instruction signal to the passenger of the automatic driving vehicle 50 and then transfer the driving of the automatic driving vehicle 50 to the passenger of the automatic driving vehicle 50.

(7) When a plurality of automatic driving control vehicles are present around the automatic driving vehicle 50, the control unit 400 of the automatic driving control device 10 in the first embodiment may designate a specific vehicle and transmit the first content signal to the vehicle, rather than transmitting the first content signal to all the plurality of automatic driving vehicles which are present around the automatic driving vehicle 50. Also, it may select a target vehicle to which the first content signal is transmitted, based on the traveling conditions of the vehicle. For example, the first content signal may be transmitted only to a vehicle traveling at a speed lower than the speed of the automatic driving vehicle 50.

(8) The communication unit 300 of the automatic driving control device 10 in the first embodiment may be configured to receive an instruction signal output as a sound or light. In the case of such a form, the contents of the instruction signal are discriminated based on the wavelength of the sound or light.

(9) In the description about the automatic driving control device 10 in the first embodiment, the course of the emergency vehicle EV is ensured by movement of the automatic driving vehicle on the road R in response to the instruction signal instructing the automatic driving vehicle to create the course for passage of the emergency vehicle EV. However, the present disclosure is not limited to this. For example, in the case where only the movement on the road R is insufficient to respond to the instruction signal, the automatic driving control device 10 may respond to the instruction signal by the movement of the automatic driving vehicle from the road R to another road.

(10) In the description about the automatic driving control device 10 in the first embodiment, the respective automatic driving vehicles constituting the platoon C move substantially simultaneously in the execution of the automatic driving according to the instruction signal S0. However, the present disclosure is not limited to this. For example, the respective automatic driving vehicles which form a platoon C may move either in the order from the vehicle at the tail end toward the leading vehicle, or in the order from the leading vehicle to the vehicle at the tail end.

(11) The automatic driving control device 10 in the first embodiment includes the first receiving unit 310, the first transmission unit 315, and the second receiving unit 320 as independent components. However, the present disclosure is not limited to this. For example, a transmission/receiving unit, which is included in place of the first receiving unit 310, the first transmission unit 315, and the second receiving unit 320, may have the functions of the first receiving unit 310, the first transmission unit 315, and the second receiving unit 320 as a part of its function.

(12) The four automatic driving vehicles constituting the platoon C in the descriptions about FIGS. 12 to 17 execute their respective automatic driving according to the instruction signal S0 after sequential transmission of content signals from the vehicle at the tail end toward the leading vehicle and then sequential transmission of content signals from the leading vehicle toward the vehicle at the tail end. However, the present invention is not limited to this. For example, there may be employed a form in which, when content signals are transmitted from the vehicle at the tail end which has received the instruction signal among the automatic driving vehicles constituting the platoon toward the leading vehicle, information about the number of vehicles showing what number the own vehicle is from the vehicle at the tail end is received together with the content signal. In such a case, if the number of vehicles indicated by the information about the number of vehicles in the own vehicle which receives the content signal and the information about the number of vehicles is not less than the preset number of vehicles, the automatic driving vehicle may execute the automatic driving according to the instruction signal S0 without waiting for the sequential transmission of the content signals from the leading vehicle toward the vehicle at the tail end. For example, when the preset number of vehicles is five, the fifth and subsequent automatic driving vehicles from the tail end, among the automatic driving vehicles constituting the platoon, execute the automatic driving according to the instruction signal S0 without waiting for the subsequent transmission of the content signals from the leading vehicle toward the vehicle at the tail end. Among the automatic driving vehicles constituting the platoon, the first to fourth automatic driving vehicles from the tail end exchange signals in a similar manner as in the respective automatic driving vehicles constituting the platoon C described in FIGS. 12 to 17, and then execute the automatic driving according to the instruction signal S0 and the content signal.

(13) In the description about the automatic driving control device 10 in the first embodiment, the instruction signal is output from the emergency vehicle. However, the subject outputting the instruction signal is not limited to this. For example, the instruction signal may be output either from a failed vehicle when the automatic driving vehicles which are present on the course of the failed vehicle are requested to give way, or from a police vehicle when the police vehicle requests the automatic driving vehicles to stop the vehicles. Examples of the case where the instruction signal is output at the time of passage of a vehicle defined as having higher priority than other general vehicles, such as a public transport, include the case where failure of a vehicle is detected, the case where abnormality of the passenger of the vehicle is detected, the case where the vehicle is requested to deliver an instruction signal from the outside of the vehicle, the case where a request is issued from the passenger of the vehicle to the vehicle, and the case where the vehicle detects the presence of other vehicles on the course of the vehicle. The instruction signal may be output, including not only a request of the subject which outputs the instruction signal, but also a reason for the request. The “reason for the request”, as used herein, refers to contents, for example, when an instruction signal for requesting to give way is output, showing the details of the reason for requesting to give way. For example, in the case of requesting to give way, the output subject is an ambulance, and the reason for requesting to give way is transporting an emergency patient.

The instruction signal may be output from a control center. In the case where the control center is the subject which outputs the instruction signal, for example, the instruction signal may be output from the control center to other automatic driving vehicles for progress of an emergency vehicle according to the request from the emergency vehicle, or may be output to other automatic driving vehicles for progress of a specific vehicle preferentially even without issuing a request from the vehicle. Also, even when the subject which outputs the instruction signal is a vehicle, the vehicle and the control center communicate with each other before output of the instruction signal, so that the contents of the instruction signal are modified, and then the modified instruction signal may be output.

The present disclosure is not limited to the above-described embodiments, examples, and variant examples and can be realized with various configurations within the scope of the present disclosure without departing from the gist of the present disclosure. For example, technical features in embodiments, examples, and variant examples corresponding to the technical features in the forms described in the Summary of the Invention can be appropriately exchanged or combined to resolve some or all of the above-described problems or achieve some or all of the above-described advantages. The technical features can be appropriately omitted unless the technical features are essential in the present specification.

(Conclusion)

As described above, the present disclosure has been achieved in light of the above-described circumstances and is accomplished in the following aspects.

According to one aspect of the present disclosure, an automatic driving control device is provided. This automatic driving control device is an automatic driving control device mounted in an automatic driving vehicle for executing automatic driving along a planned travelling route, including: a driving execution unit that executes driving of the automatic driving vehicle; a communication unit that communicates with outside of the automatic driving vehicle; and a control unit that executes the automatic driving by controlling the driving execution unit, wherein the communication unit has a first receiving unit that receives instruction signals for instructing driving contents of the automatic driving vehicle, wherein the control unit has a first determination unit that determines provisional driving contents which are the driving contents of the automatic driving vehicle according to the instruction signals, when the instruction signals are received during execution of the automatic driving, and wherein the control unit executes the automatic driving using the determined provisional driving contents. According to such an aspect, the automatic driving vehicle, even when receiving instruction signals for indicating driving contents during automatic driving, can execute proper automatic driving using the provisional driving contents determined according to the instruction signals.

The aspect of the present disclosure is not limited to the automatic driving control device, and can also be applied to various forms such as vehicles equipped with the automatic driving control device and methods for controlling automatic driving of vehicles. Also, the present disclosure is in no way limited to the forms described above, and can be implemented in various forms within the scope without departing from the gist of the present disclosure.

What is claimed is:

1. An automatic driving control device mounted in an automatic driving vehicle for executing automatic driving along a planned travel route, the comprising:
a driving execution unit that executes driving of the automatic driving vehicle;
a communication unit that communicates with outside of the automatic driving vehicle; and
a control unit that executes the automatic driving by controlling the driving execution unit, wherein
the communication unit has a first receiving unit that receives instruction signals for instructing driving contents of the automatic driving vehicle,
the control unit has a first determination unit that determines provisional driving contents which are the driving contents of the automatic driving vehicle according to the instruction signals, when the instruction signals are received during execution of the automatic driving,
the control unit executes the automatic driving using the determined provisional driving contents,
and wherein the communication unit further has:
a first transmission unit that transmits first content signals indicating the driving contents indicated by the instruction signals and the provisional driving contents to any other automatic driving vehicle; and
a second receiving unit that receives, from the other automatic driving vehicle, second content signals indicating the driving contents to be executed by the other automatic driving vehicle upon reception of the first content signals,
wherein the control unit further has a second determination unit that determines conclusive driving contents which are the driving contents of the automatic driving vehicle according to the driving contents indicated by the second content signals received by the second receiving unit and the driving contents indicated by the instruction signals, and
the control unit executes the automatic driving based on the conclusive driving contents.

2. The automatic driving control device according to claim 1,
wherein the driving contents of the automatic driving include traveling of the automatic driving vehicle in the front, rear, right and left directions.

3. The automatic driving control device according to claim 1,
wherein the control unit, when receiving a plurality of the instruction signals during execution of the automatic driving, executes the automatic driving using the provisional driving contents determined according to the instruction signals, in accordance with preset priority, in descending order of the priority.

4. The automatic driving control device according to claim 1,
wherein the control unit communicates with the other automatic driving vehicle which has received the first content signals via the communication unit to execute the automatic driving based on the conclusive driving contents in sync with the execution of the automatic driving of the other automatic driving vehicle upon reception of the first content signals.

5. The automatic driving control device according to claim 4,
wherein, when the driving contents to be executed by the automatic driving vehicle are traveling in either one of the right and left directions, the driving contents to be executed by the other automatic driving vehicle are traveling in the other of the right and left directions, which is different from that of the automatic driving vehicle, and the control unit executes the automatic driving of the automatic driving vehicle in sync with the execution of the automatic driving of the other automatic driving vehicle, in the case where the other automatic driving vehicle is present within a range set on the basis of the automatic driving vehicle as a reference, the control unit adjusts the position of the automatic driving vehicle relative to the other automatic driving vehicle so that the other automatic driving vehicle is positioned outside the range.

6. The automatic driving control device according to claim 4,
wherein the communication unit further has a second transmission unit that transmits a preset signal to the other automatic driving vehicle, and
wherein the control unit allows the second transmission unit to transmit the preset signal, and then executes the automatic driving based on the conclusive driving contents.

7. The automatic driving control device according to claim 1,
wherein the control unit further has an information acquisition unit that communicates with the other automatic driving vehicle to acquire identification information on the other automatic driving vehicle, and
wherein the first transmission unit, when transmitting the first content signals, transmits the first content signals together with the preliminarily acquired identification information on the other automatic driving vehicle.

8. The automatic driving control device according to claim 1,
wherein the communication unit further has:
a first transmission unit that transmits first content signals indicating the driving contents indicated by the instruction signals and the provisional driving contents to any other automatic driving vehicle; and
wherein, when the control unit executes the automatic driving based on the provisional driving contents, the provisional driving contents to be executed by the automatic driving vehicle are traveling in either one of the right and left directions upon reception of the first content signals, the driving contents to be executed by the other automatic driving vehicle are traveling in the other of the right and left directions, which is different from that of the automatic driving vehicle, and the automatic driving vehicle and the other automatic driving vehicle each execute the automatic driving, in the case where the other automatic driving vehicle is present within a range set on the basis of the automatic driving vehicle as a reference, the control unit adjusts the position of the automatic driving vehicle relative to the other automatic driving vehicle so that the other automatic driving vehicle is positioned outside the range.

9. An automatic driving control device mounted in an automatic driving vehicle for executing automatic driving along a planned travel route, the comprising:
a driving execution unit that executes driving of the automatic driving vehicle;
a communication unit that communicates with outside of the automatic driving vehicle; and
a control unit that executes the automatic driving by controlling the driving execution unit,
wherein the communication unit has a first receiving unit that receives instruction signals for instructing driving contents of the automatic driving vehicle,
wherein the control unit has a first determination unit that determines provisional driving contents which are the driving contents of the automatic driving vehicle according to the instruction signals, when the instruction signals are received during execution of the automatic driving,
wherein the control unit executes the automatic driving using the determined provisional driving contents,
wherein the communication unit further has:
a first transmission unit that transmits first content signals indicating the driving contents indicated by the instruction signals and the provisional driving contents to any other automatic driving vehicle; and
wherein, when the control unit executes the automatic driving based on the provisional driving contents, the provisional driving contents to be executed by the automatic driving vehicle are traveling in either one of the right and left directions upon reception of the first content signals, the driving contents to be executed by the other automatic driving vehicle are traveling in the other of the right and left directions, which is different from that of the automatic driving vehicle, and the automatic driving vehicle and the other automatic driving vehicle each execute the automatic driving, in the case where the other automatic driving vehicle is present within a range set on the basis of the automatic driving vehicle as a reference, the control unit adjusts the position of the automatic driving vehicle relative to the other automatic driving vehicle so that the other automatic driving vehicle is positioned outside the range.

10. The automatic driving control device according to claim 9,
wherein the driving contents of the automatic driving include traveling of the automatic driving vehicle in the front, rear, right and left directions.

11. The automatic driving control device according to claim 9,
wherein the control unit, when receiving a plurality of the instruction signals during execution of the automatic driving, executes the automatic driving using the provisional driving contents determined according to the instruction signals, in accordance with preset priority, in descending order of the priority.
